(19) United States
(12) Patent Application Publication
(10) Pub. No.: US 2018/0100391 A1
(43) Pub. Date: Apr. 12, 2018

(54) H2S SENSOR BASED ON POLYMERIC CAPILLARY TUBING FILLED WITH AN INDICATING FLUID

(71) Applicant: Rocco DiFoggio, Houston, TX (US)

(72) Inventor: Rocco DiFoggio, Houston, TX (US)

(73) Assignee: Baker Hughes Incorporated, Houston, TX (US)

(21) Appl. No.: 15/291,380

(22) Filed: Oct. 12, 2016

(51) Int. Cl. E21B 49/08; G01V 8/12

(52) U.S. Cl. CPC E21B 49/08; G01N 2021/7783; G01V 8/12

(57) ABSTRACT

An apparatus for sensing a chemical of interest in a fluid of interest includes: a tube permeable to the chemical of interest, having a polymer, and configured to be disposed into the fluid of interest; and a reactant disposed in a hollow portion of the tube and configured to react with the chemical of interest causing a change to transmissiveness of light. The apparatus further includes: a light source configured to illuminate the reactant; a photodetector configured to detect light traversing the reactant; a processor coupled to the photodetector and configured to determine a rate of change of detected light in response to the chemical of interest reacting with the reactant in order to sense the chemical of interest; and a reactant purging system in fluid communication with the hollow portion and configured to purge out pre-existing reactant present in the hollow portion with new unreacted reactant.

### BACKGROUND

Drilling tools and wireline tools are used to reach and evaluate subterranean formations that produce oil and gas. These tools often incorporate various sensors, instruments and control devices in order to carry out any number of downhole operations. The operations may include formation testing, fluid analysis, and tool monitoring and control.

Information about the subterranean formations traversed by the borehole may be obtained by any number of techniques. Techniques used to obtain formation information include obtaining one or more downhole fluid samples produced from the subterranean formations. Downhole fluids, as used herein include any one or any combination of drilling fluids, return fluids, connate formation fluids, and formation fluids that may be contaminated by materials and fluids such as mud filtrates, drilling fluids and return fluids. Downhole fluid samples are often retrieved from the borehole and tested in a rig-site or remote laboratory to determine properties of the fluid samples, which properties are used to estimate formation properties. Modern fluid sampling also includes various downhole tests to estimate fluid properties while the fluid sample is downhole.

Some formations produce hazardous fluids, such as hydrogen sulfide (H2S) gas and other gases that may damage tools, present safety hazards to surface personnel, and that may reduce the viability of the formation for producing useful hydrocarbons. Surface testing for these fluids requires bringing the fluid to the surface. For H2S gas measurement, unless one is careful in the selection of sample tank material, retrieval of a sample to the surface runs the risk of under-reporting the actual H2S levels. The reason is that H2S chemically reacts with many materials. The unreacted, remaining amount of H2S in the sample that is finally measured at the surface may be significantly less than the total amount of H2S that had been in the original sample so that the H2S concentration gets under reported. That is another reason that an in-situ measurement is preferable. However, an in-situ measurement of the chemical composition of these fluids presents unique problems due to the rigorous downhole environment.

The environment in a well presents many challenges to maintain the tools used at depth due to vibration, harsh chemicals and temperature. Temperature in downhole tool applications presents a unique problem to these tools. High downhole temperatures may reach as high as 392° F. (200° C.) or more making it difficult to operate sensitive electronic components in the environment. Space in a downhole carrier is usually limited to a few inches in diameter. Traditional cooling systems typically utilize large amounts of power and take up valuable space in the tool carrier and add an additional failure point in the system. Hence, it would be appreciated in the drilling industry if in-situ sensors were developed to sense fluids of interest.

### BRIEF SUMMARY

Disclosed is an apparatus for sensing a chemical of interest in a fluid of interest. The apparatus includes: a tube permeable to the chemical of interest, having a polymer, and configured to be disposed into the fluid of interest; a reactant disposed in a hollow portion of the tube and configured to react with the chemical of interest causing a change to transmissiveness of light; a light source configured to illuminate the reactant; a photodetector configured to detect light traversing the reactant; a processor coupled to the photodetector and configured to determine a rate of change of detected light in response to the chemical of interest reacting with the reactant in order to sense the chemical of interest; and a reactant purging system in fluid communication with the hollow portion and configured to purge out pre-existing reactant present in the hollow portion with new unreacted reactant.

Also disclosed is a method for sensing a chemical of interest in a fluid of interest. The method includes: disposing a tube in the fluid of interest, the capillary tube being permeable to the chemical of interest and having a polymer; disposing a reactant in a hollow portion of the tube, the reactant being configured to react with the chemical of interest causing a change to transmissiveness of light of the reactant; illuminating the reactant using a light source; detecting light traversing the reactant using a photodetector; determining a rate of change of detected light over time in response to the chemical of interest reacting with the reactant using a processor in order to sense the chemical of interest; and purging out pre-existing reactant present in the hollow portion with new unreacted reactant using a reactant purging system.

### BRIEF DESCRIPTION OF THE DRAWINGS

The following descriptions should not be considered limiting in any way. With reference to the accompanying drawings, like elements are numbered alike:

FIG. 1 is a cross-sectional view of a non-limiting example of a drilling system in a measurement-while-drilling (“MWD”) arrangement having a fluid detection sensor;

FIG. 2 depicts aspects of a sample chamber disposed in the drilling system;

FIG. 3 depicts aspects of the fluid detection sensor; and

FIG. 4 is a flow chart for a method for detecting a chemical of interest in a fluid of interest.

### DETAILED DESCRIPTION

A detailed description of one or more embodiments of the disclosed apparatus and method presented herein by way of exemplification and not limitation with reference to the figures.

The present disclosure uses terms, the meaning of which terms will aid in providing an understanding of the discussion herein. As used herein, high temperature refers to a range of temperatures typically experienced in oil production well boreholes. For the purposes of the present disclosure, high temperature and downhole temperature include a range of temperatures from about 100° C. to about 200° C. (about 212° F. to about 392° F.). In recent years, as wells have gotten deeper, a few wells now exceed 200° C. One or more embodiments disclosed herein may use the term carrier. The term “carrier” as used herein means any device, device component, combination of devices, media and/or member that may be used to convey, house, support or otherwise facilitate the use of another device, device component, combination of devices, media and/or member. Exemplary non-limiting carriers include drill strings of the coiled tube type, of the jointed pipe type and any combination or portion thereof. Other carrier examples include casing pipes, wirelines, wireline sondes, slickline sondes, drop shots, downhole subs, bottom hole assemblies (BHA's), drill string inserts, modules, internal housings and substrate portions thereof.

Disclosed are embodiments of apparatuses and methods for sensing a chemical of interest in a fluid of interest. The term “sensing” may include detecting a presence of the chemical and/or a concentration of the chemical in the fluid. The apparatuses and methods may be used at the surface of the earth or in a borehole (i.e., downhole) in conjunction with a carrier. When used downhole the apparatuses can withstand and operate in the high temperature environment.

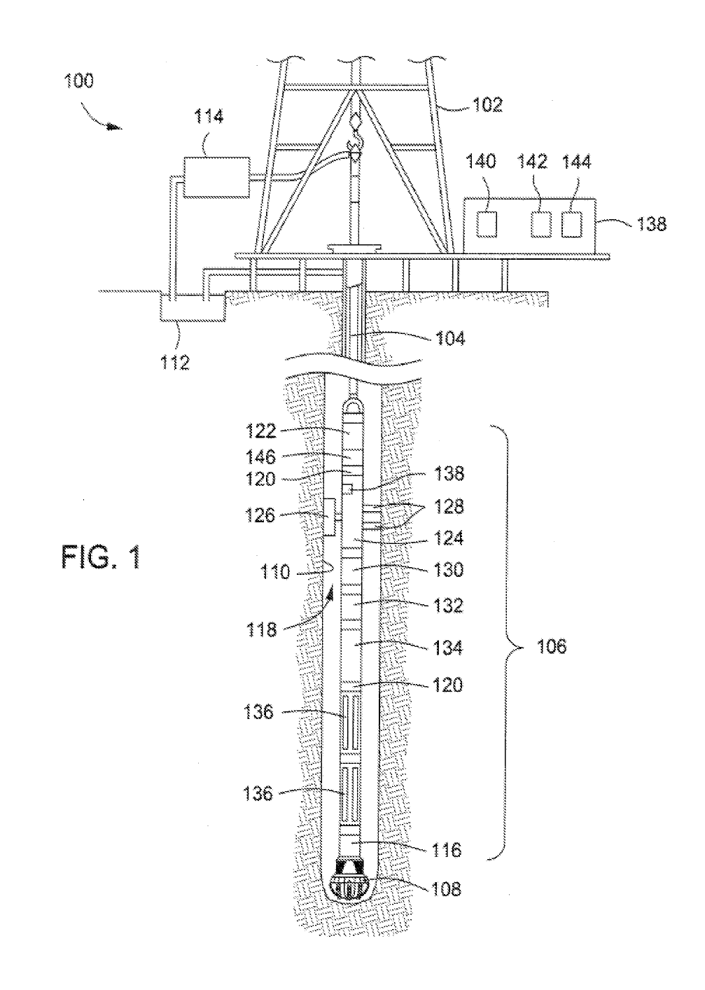

FIG. 1 schematically illustrates a non-limiting example of a drilling system 100 in a measurement-while-drilling (“MWD”) arrangement according to several non-limiting embodiments of the disclosure. A derrick 102 supports a drill string 104 operating in this example as a carrier, which may be a coiled tube or drill pipe. The drill string 104 may carry a bottom hole assembly (“BHA”) referred to as a downhole sub 106 and a drill bit 108 at a distal end of the drill string 104 for drilling a borehole 110 through earth formations.

Drilling operations according to several embodiments may include pumping drilling fluid or “mud” from a mud pit 112, and using a circulation system 114, circulating the mud through an inner bore of the drill string 104. The mud exits the drill string 104 at the drill bit 108 and returns to the surface through an annular space between the drill string 104 and inner wall of the borehole 110. The drilling fluid is designed to provide a hydrostatic pressure that is greater than the formation pressure to avoid blowouts. The pressurized drilling fluid may further be used to drive a drilling motor 116 and may be used to provide lubrication to various elements of the drill string 104.

In the non-limiting embodiment of FIG. 1, the downhole sub 106 includes a formation evaluation tool 118. The formation evaluation tool 118 may include an assembly of several tool segments that are joined end-to-end by threaded sleeves or mutual compression unions 120. An assembly of tool segments suitable for the present disclosure may include a power unit 122 that may include one or more of a hydraulic power unit, an electrical power unit and an electro-mechanical power unit. In the example shown, a formation sample tool 124 may be coupled to the formation evaluation tool 118 below the power unit 122.

The exemplary formation sample tool 124 shown comprises an extendable probe 126 that may be opposed by bore wall feet 128. The extendable probe 126, the opposing feet 128, or both may be hydraulically and/or electro-mechanically extendable to firmly engage the well borehole wall. The formation sample tool 124 may be configured for extracting a formation core sample, a formation fluid sample, formation images, nuclear information, electromagnetic information, and/or downhole information, such as pressure, temperature, location, movement, and other information. In several non-limiting embodiments, other formation sample tools not shown may be included in addition to the formation sample tool 124 without departing from the scope of the disclosure.

Continuing now with FIG. 1, several non-limiting embodiments may be configured with the formation sample tool 124 operable as a downhole fluid sampling tool. In these embodiments, a large displacement volume motor/pump unit 130 may be provided below the formation sample tool 124 for line purging. A similar motor/pump unit 132 having a smaller displacement volume may be included in the tool in a suitable location, such as below the large volume pump, for quantitatively monitoring fluid received by the downhole evaluation tool 118 via the formation sample tool 124. As noted above, the formation sample tool 124 may be configured for any number of formation sampling operations. Construction and operational details of a suitable non-limiting fluid sample tool 124 for extracting fluids are more described by U.S. Pat. No. 5,303,775, the specification of which is incorporated herein by reference.

The downhole evaluation tool 118 may include a downhole evaluation system 134 for evaluating several aspects of the downhole sub 106, of the drilling system 100, of the downhole fluid in and/or around the downhole sub 106, formation samples received by the downhole sub 106, and of the surrounding formation. The downhole evaluation system 134 may include a sample chamber 150 configured to hold a sample of fluid extracted by the formation sample tool 124 for analysis by a chemical sensor.

One or more formation sample containers 136 may be included for retaining formation samples received by the downhole sub 106. In several examples, the formation sample containers 136 may be individually or collectively detachable from the downhole evaluation tool 118.

A downhole transceiver 146 may be coupled to the downhole sub 106 for bidirectional communication with a surface transceiver 140. The surface transceiver 140 communicates received information to a controller 138 that includes a memory 142 for storing information and a processor 144 for processing the information. The memory 142 may also have stored thereon programmed instructions that when executed by the processor 144 carry out one or more operations and methods that will become apparent in view of the discussion to follow. The memory 142 and processor 144 may be located downhole on the downhole sub 106 in several non-limiting embodiments.

The drilling system 100 shown in FIG. 1 is only an example of how various tools may be carried into a well borehole using the downhole sub 106. Tools according to the present disclosure may further include direct measurement tools for evaluating fluid characteristics such as content and concentrations. In one or more embodiments, the downhole sub 106 may be used to carry a downhole gas detector for evaluating fluids in-situ. The following discussion and associated figures will present several exemplary downhole gas detectors according to the disclosure.

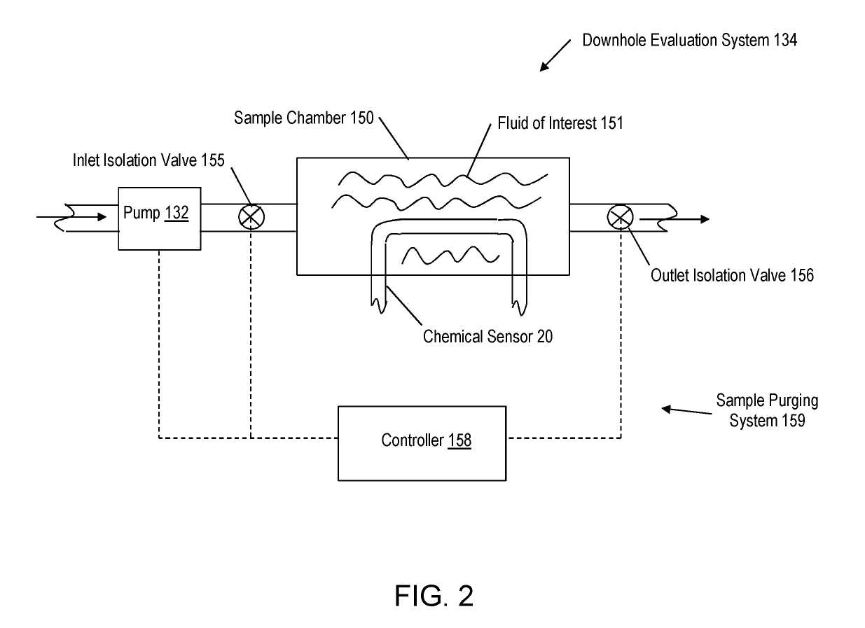

FIG. 2 depicts aspects of the sample chamber 150 and sample purging system 159 configured to purge the sample chamber 150 of any fluid present in the sample chamber and to fill the chamber with new fluid of interest. The sample chamber 150 is configured to contain a sample of a fluid of interest 151 such as fluid extracted by the fluid sample tool 124. A sensing portion of a chemical sensor 20 is disposed within the sample chamber 150. The chemical sensor 20 is configured to sense a chemical of interest in the fluid of interest 151. The pump 132 is configured to pump the fluid of interest 151 into the sample chamber 150. An inlet isolation valve 155 and an outlet isolation valve 156 are configured to isolate the sample of the fluid of interest 151 within the sample chamber 150. A controller 158 is configured to operate the pump 132, the inlet isolation valve 155 and the outlet isolation valve 156. In one or more embodiments, the controller 158 is configured to operate the pump 132 and open the isolation valves 155 and 156 for a selected time period in order to fill the sample chamber with the sample of the fluid of interest 151 and purge out any fluid already existing in the sample chamber 151. After the sample chamber 150 is filled with a new sample of the fluid of interest, the controller 158 turns off the pump 132 and closes the isolation valves 155 and 156. In one or more embodiments, the time period is selected based on the pumping capacity of the pump 132 and the volume of the sample chamber 150 to insure that any pre-existing fluid is completely purged out. The controller 158 may include a timer or clock for performing timing functions associated with the time period. In an alternative embodiment, a sample chamber may not be used, but the chemical sensor 20 may be inserted directly into the fluid of interest without a sample being taken and isolated. In another embodiment, the chemical sensor 20 may be inserted into a flow of the fluid of interest where the flow may be continuous or the flow may occur only for selected time intervals. The selected time intervals may be evenly spaced or they may be initiated by a triggering event.

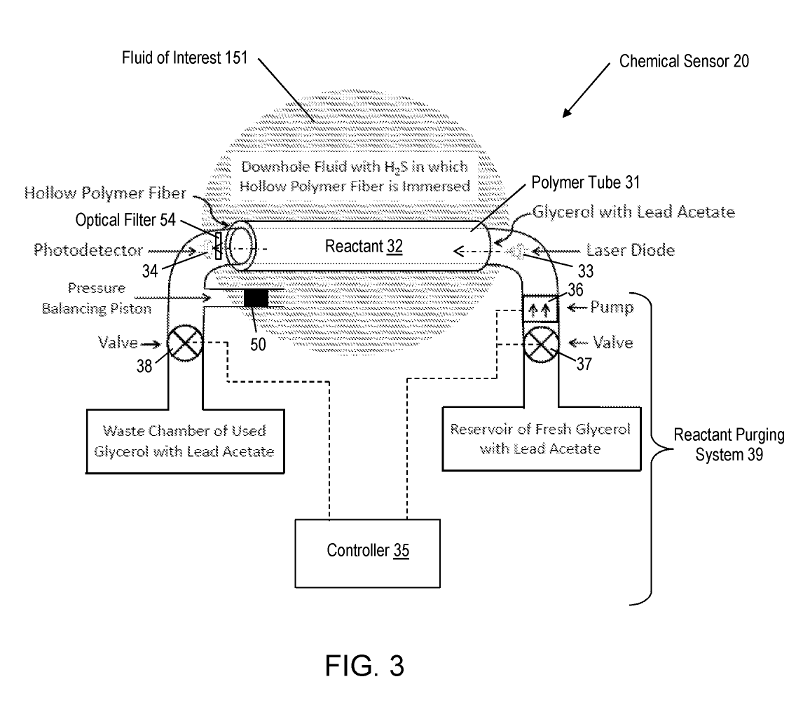

FIG. 3 depicts aspects of the chemical sensor 20 configured to sense a property of the sample of the fluid of interest 151. The chemical sensor 20 includes a hollow tube or capillary tube 31 made of a polymer. The polymer tube 31 allows the chemical of interest to diffuse through it and enter the hollow portion of the tube. In one or more embodiments, the tube 31 may be manufactured using a high-temperature polymer such as the transparent sulfone polymers, such as a polysulfone, a polyethersulfone, or a combination thereof. Optical transparency of the polymer would allow measurement of the optical absorbance of the fluid within the hollow capillary tube using a light beam configured perpendicular to the axis of the capillary tube. For a light beam configured parallel to the axis of the capillary tube and traveling only within the filling fluid, optical transparency of the walls of the capillary tube is not necessary so that an opaque but high temperature polymer such as polyetherimide could be used. Each of these materials may be used in high-temperatures as may be experienced in the downhole environment. For example, polysulfones are capable of use in temperatures at least up to 174° C. and polyphenylsulfones are usable to about 204° C. and polyetherimides to 215° C. In one or more embodiments, the tube 31 is transparent to light so that the hollow portion of the tube can be interrogated by light. In one or more embodiments, the tube 31 is a capillary tube made from Udel (a polysulfone useable to 174° C.), Radel A (a polyethersulfone useable to 204° C.), or Radel (a polyphenylsulfone useable to 204° C.), or ULTEM (a polyetherimide useable to 215° C.) all of which are available from Paradigm Optics, Incorporated of Vancouver, Wash. In one or more embodiments, the outer diameter of the capillary tube varies from 150 to 500 microns while the inner diameter varies from 50 to 206 microns. In one or more embodiments, a wall thickness of the capillary tube is about 50 microns.

Disposed in the hollow portion of the tube 31 is a reactant 32. The reactant 32 is a mixture of a carrier fluid and a “colorimetric” material in which the color of the material changes due to a chemical reaction with a certain chemical on interest that has diffused through the wall of the tube 31. In one or more embodiments, the color of the colorimetric material darkens due the chemical reaction. That is, the “transmissivity” or the ability to transmit light diminishes due to the chemical reaction. In general, the chemical of interest is in a gaseous state and can diffuse through the wall of the tube 31, although the chemical sensor 20 may also be responsive to any chemical of interest in liquid form that can diffuse through the wall of the tube 31.

In one or more embodiments, the reactant 32 may include a small amount (1%-2% by weight) of a compound that contains lead, lead acetate, iron, or another substance that changes color upon exposure to a selected gas such as H2S. In one or more embodiments, lead sulfate, which melts at the very high temperature of 1170° C., may be used as the reactant 32. In other embodiments, an iron compound may be used as the reactant 32. For example, hydrogen sulfide reacts with ferric oxide, Fe2O3, which is rust colored, to form ferrous sulfide, FeS2, which is black. Elemental iron particles might also be used as the reactant 32. In other non-limiting examples, high temperature organic compounds that change color upon exposure to a selected gas such as H2S may be used as the reactant 32. Similarly, for SO2 detection, the reactant 32 could be an alkali vanadate such as sodium vanadate, which doesn't melt until 858° C. or potassium dichromate, which doesn't melt until 398° C. Similarly, other gases could be detected using other colorimetric materials. In one or more embodiments, a chemical reactant such lead acetate is dissolved or suspended in a carrier fluid or solvent, such as glycerol, which has a boiling point of 290° C.

Still referring to FIG. 3, the chemical sensor 20 includes a light source 33 and a photodetector 34. The light source 33 is configured to illuminate the reactant 32 in the tube 31. The light source 33 may be disposed internal to the tube 31 (such as by a tiny optical fiber within the hollow of the capillary tube and running parallel to its axis) or external to the tube 31 and, thus, launch light through the wall of the tube 31 in order to illuminate the reactant 32. In one or more embodiments, the light source 33 can be a laser diode, a superluminescent diode, or a small incandescent light source. The photodetector 34 is configured to receive light that traverses the reactant 32 due to the illuminating and to provide an output signal to a controller 35. The output signal is indicative of an intensity of the received light. In one or more embodiments, the light travels a few centimeters before it is received by the photodetector 34.

The chemical sensor 20 further includes reactant purging system 39. The reactant purging system 39 includes a reactant pump 36 configured to pump the reactant 32 into the hollow portion of the tube 31. A reactant inlet valve 37 and a reactant outlet valve 38 are configured to isolate a fixed amount of the reactant 32 in the tube 31. The controller 35 is configured to operate the pump 36 and the valves 37 and 38 so that the fixed amount of the reactant 32 stays in place while the sensor 29 is sensing. When a sensing measurement is complete, the controller 35 operates the pump 36 and opens the valves 37 and 38 so that the reactant 32 that has already reacted with the chemical of interest is purged from the tube 31 and a new fixed amount of unreacted reactant is pumped into the tube 31. After the new fixed amount of unreacted reactant is pumped into the tube 31, the controller 35 turns off the pump 36 and closes the valves 37 and 38 so that the chemical sensor 20 can perform a new sensing measurement. Fresh unreacted reactant 32 is stored in a reservoir 51, while used reactant 32 is stored in a waste chamber 52. A pressure balancing piston 50 is used to balance the pressure between the reactant 32 within the tube 31 and the fluid of interest surrounding the tube 31 in order to prevent the tube 31 from deforming or collapsing due to a pressure imbalance.

By measuring the intensity of light received by the photodetector 34 over time, the controller 35 can be configured to determine a rate of change of detected light over time in response to the chemical of interest reacting with the reactant. The rate of change may be determined in various ways. For example, the rate of change may be an average rate of change determined over a specified or desired time interval (e.g., average=(intensity at time1−intensity at time2)/(time1−time2)) or the rate of change may be determined to be a first derivative of light intensity with respect to time using closely spaced measurement points (e.g., measurements taken every 0.5 seconds). In one or more embodiments the first derivative is determined by using a Savitzky-Golay digital filter that is equivalent to fitting a smoothing polynomial to a discrete number of evenly-spaced measurement points and computing the derivative of that polynomial at the center of the measurement interval. In that the controller 35 is configured to determine the rate of change of detected light intensity over time, the controller 35 includes clock or timer for synchronizing or timing the receiving of light intensity measurements.

Using the rate of change of detected light over time in response to the chemical of interest reacting with the reactant, the concentration of the chemical of interest in the fluid of interest can be determined. In one or more embodiments, a value of the rate of change is referenced to a look-up table or graphical curve that relates the rate of change value to a concentration value. In general, the chemical of interest diffuses through void spaces between polymer chains in the polymer tube 31. It can be appreciated that as temperature increases the void spaces open up or increase and as pressure increases the void spaces close or decrease. As can be seen, molecular transport through a polymer membrane depends upon many factors. To obtain a quantitative measurement of the concentration of analyte molecules in solution from the change in optical properties of the indicator liquid or reactant within the hollow polymer capillary tube in order to generate the reference table or curves, an experimental calibration can be performed, as a function of temperature and pressure, for that analyte (i.e., chemical of interest) using known concentrations of expected fluids in which are immersed a hollow capillary tube of the same polymer having the same inner and outer diameters (and wall thickness) and containing the same internal indicator fluid. Alternatively, the reference table or curves may be obtained by diffusion analysis of the polymer tube using equations known in the art such as Fick's law of diffusion. Capillary tubes with multiple internal channels (up to 19 channels) are commercially available so other, more complicated configurations are also possible such as using different indicator fluids in different channels of the same polymeric capillary to detect multiple gases. Also, an in-situ or downhole calibration may be performed. In one or more embodiments, the in-situ or downhole calibration is performed using an adjacent pair of single-channel capillary tubes having different wall thicknesses each containing the same filling fluid could be used to determine the gas diffusion rate per unit wall thickness at a given downhole pressure and temperature, which would further assist in working backwards to get a quantitative estimate of the gas concentration in the fluid of interest. Hence, by knowing the gas diffusion rate per unit wall thickness and measuring the rate of change of an optical characteristic of the reactant in the capillary tube, the gas concentration in the fluid of interest can be determined at the in-situ pressure and temperature conditions. An advantage of an in-situ or downhole calibration is that there is no need for an oven or a pressure generator that would be required in a surface laboratory.

While the above disclosure discusses detecting H2S as an example, it can be appreciated that the disclosure may be applied to sensing other chemicals of interest. Similarly, solvents other than glycerol may be used as a liquid solvent for the indicator reactant. For example, corrosive gases in hydrocarbons whose concentrations are useful to know include hydrogen sulfide, carbon dioxide, and sulfur dioxide. The high boiling point (290° C. at 1 bar) liquid, glycerol, has three —OH groups which give it solubility characteristics similar to water (100° C. boiling point at 1 bar), which has two —OH groups. Therefore, an indicating reactant that can be used in water may also be useable in glycerol. Because borehole temperatures often exceed 100° C., glycerol may be one example to use as the liquid solvent or carrier fluid for the indicator although pressurized water could be used within the polymer capillary tube. The H2S indicator, lead acetate is soluble in either water or glycerol. Aqueous solutions of polydiacetylene (PDA-1), functionalized with amines and imidazolium groups change from blue to red in the presence of CO2. Similarly, aqueous solutions of sodium vanadate are an indicator for SO2. In that some reactions may cause a color change, an optical filter 54 may be disposed in front of the photodetector 34 in order to detect a specified color of received light as illustrated in FIG. 3. Alternative to an optical filter and single photodetector, a spectrometer may be used to obtain the entire optical spectrum of light transmitted through the fluid.

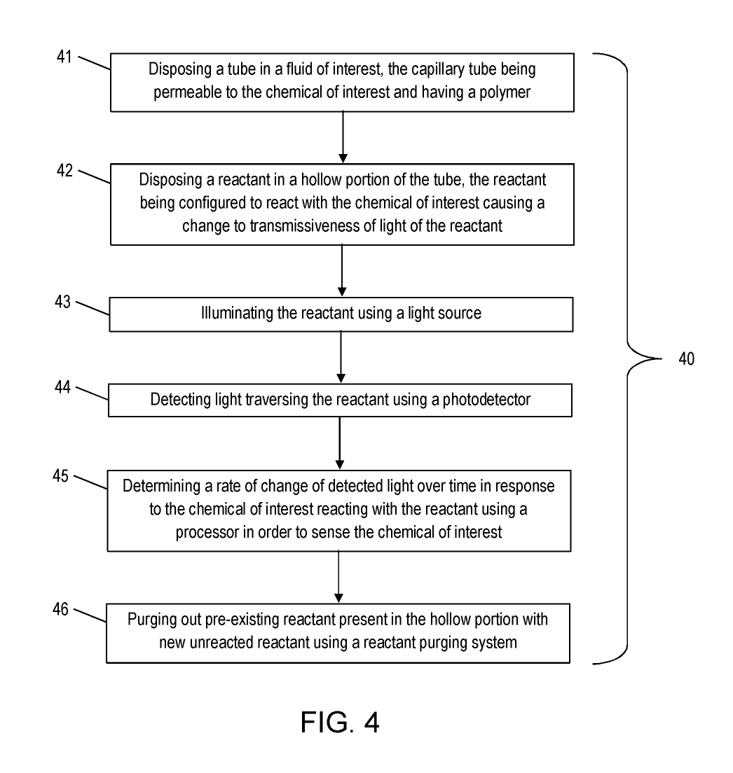

FIG. 4 is a flow chart for a method 40 for detecting a chemical of interest in a fluid of interest. Block 41 calls for disposing a tube in the fluid of interest, the capillary tube walls being permeable to the chemical of interest and having a polymer. In one or more embodiments, the tube is a capillary tube. Block 42 calls for disposing a reactant in a hollow portion of the tube, the reactant being configured to react with the chemical of interest causing a change to transmissiveness of light of the reactant. Block 43 calls for illuminating the reactant using a light source. Block 44 calls for detecting light traversing the reactant using a photodetector. Block 45 calls for determining a rate of change of detected light over time in response to the chemical of interest reacting with the reactant using a processor in order to sense the chemical of interest. Block 45 may also include correlating the rate of change over time to a reference to determine a concentration of the chemical of interest in the fluid of interest. Block 46 calls for purging out pre-existing reactant present in the hollow portion with new unreacted reactant using a reactant purging system.

The method 40 may also include conveying a carrier through a borehole penetrating an earth formation, the tube being disposed on the carrier, wherein the fluid of interest is a formation fluid.

Set forth below are some embodiments of the foregoing disclosure:

### Embodiment 1

An apparatus for sensing a chemical of interest in a fluid of interest, the apparatus comprising: a tube permeable to the chemical of interest, comprising a polymer, and configured to be disposed into the fluid of interest; a reactant disposed in a hollow portion of the tube and configured to react with the chemical of interest causing a change to transmissiveness of light; a light source configured to illuminate the reactant; a photodetector configured to detect light traversing the reactant; a processor coupled to the photodetector and configured to determine a rate of change of detected light in response to the chemical of interest reacting with the reactant in order to sense the chemical of interest; and a reactant purging system in fluid communication with the hollow portion and configured to purge out pre-existing reactant present in the hollow portion with new unreacted reactant.

### Embodiment 2

The apparatus according to any prior embodiment, wherein the processor is further configured to determine a concentration of the chemical of interest in the fluid of interest by correlating the rate of change to the concentration.

### Embodiment 3

The apparatus according to any prior embodiment, wherein the rate of change comprises a first derivative of a value of an output of the photodetector over time.

### Embodiment 4

The apparatus according to any prior embodiment, wherein the processor is further configured to determine the first derivative using a Savitzky-Golay digital filter.

### Embodiment 5

The apparatus according to any prior embodiment, wherein the reactant purging system comprises: a reservoir configured to contain unreacted reactant; and a waste chamber configured to contain reacted reactant.

### Embodiment 6

The apparatus according to any prior embodiment, the reactant purging system further comprising: a pump configured to pump the unreacted reactant from the reservoir into the hollow portion of the capillary tube; a tube isolation valve configured to isolate the reactant in the hollow portion of the capillary tube; and a reactant purging system controller in communication with the pump and the isolation valve and configured to operate the pump and the isolation valve to purge out the pre-existing reactant present in hollow portion with the new unreacted reactant.

### Embodiment 7

The apparatus according to any prior embodiment, further comprising a pressure balancing piston in pressure communication with the reactant disposed in the hollow portion of the capillary tube.

### Embodiment 8

The apparatus according to any prior embodiment, further comprising a sample chamber configured to contain a sample of the fluid of interest, wherein the capillary tube is disposed within the sample chamber.

### Embodiment 9

The apparatus according to any prior embodiment, further comprising a sample purging system configured to purge a pre-existing sample of the fluid of interest in the sample chamber with a new sample of the fluid of interest.

### Embodiment 10

The apparatus according to any prior embodiment, wherein the sample purging system comprises: a sample purging pump configured to pump a sample of the fluid of interest into the sample chamber; a sample chamber isolation valve configured to isolate the sample of the fluid of interest in the sample chamber; and a sample purging system controller in communication with the sample purging pump and the sample chamber isolation valve and configured to operate the sample purging pump and the sample chamber isolation valve to purge out the pre-existing sample of the fluid of interest present in sample chamber with the new sample of the fluid of interest.

### Embodiment 11

The apparatus according to any prior embodiment, wherein the chemical of interest of interest is a gas.

### Embodiment 12

The apparatus according to any prior embodiment, wherein the chemical of interest includes at least one of hydrogen sulfide (H2S), carbon dioxide, and sulfur dioxide.

### Embodiment 13

The apparatus according to any prior embodiment, wherein the fluid of interest is oil.

### Embodiment 14

The apparatus according to any prior embodiment, further comprising a carrier configured to be conveyed through a borehole penetrating an earth formation, the capillary tube being disposed on the carrier, wherein the fluid of interest is a formation fluid.

### Embodiment 15

The apparatus according to any prior embodiment, wherein the polymer is configured to withstand temperatures in a downhole environment.

### Embodiment 16

The apparatus according to any prior embodiment, wherein the polymer comprises one or more sulfone polymers.

### Embodiment 17

The apparatus according to any prior embodiment, wherein the polymer comprises one or more of a polysulfone, a polyethersulfone, a polyphenylsulfone, a polyetherimide, or a combination thereof.

### Embodiment 18

The apparatus according to any prior embodiment, wherein the reactant comprises one of more of lead, lead acetate, iron, an iron compound, ferric acid, elemental iron particles, an organic compound, or combination thereof.

### Embodiment 19

A method for sensing a chemical of interest in a fluid of interest, the method comprising: disposing a tube in the fluid of interest, the capillary tube being permeable to the chemical of interest and comprising a polymer; disposing a reactant in a hollow portion of the tube, the reactant being configured to react with the chemical of interest causing a change to transmissiveness of light of the reactant; illuminating the reactant using a light source; detecting light traversing the reactant using a photodetector; determining a rate of change of detected light over time in response to the chemical of interest reacting with the reactant using a processor in order to sense the chemical of interest; and purging out pre-existing reactant present in the hollow portion with new unreacted reactant using a reactant purging system.

### Embodiment 20

The method according to any prior embodiment, further comprising conveying a carrier through a borehole penetrating an earth formation, the tube being disposed on the carrier, wherein the fluid of interest is a formation fluid.

In support of the teachings herein, various analysis components may be used, including a digital and/or an analog system. For example, the surface transceiver 140, the surface controller 138, the controller 158, or the controller 35 may include digital and/or analog systems. Controller functions may be consolidated into one controller or distributed amongst a plurality of controllers. The system may have components such as a processor, storage media, memory, input, output, communications link (wired, wireless, optical or other), user interfaces (e.g., a display or printer), software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the spirit and scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for sensing a chemical of interest in a fluid of interest, the apparatus comprising:
a tube permeable to the chemical of interest, comprising a polymer, and configured to be disposed into the fluid of interest;
a reactant disposed in a hollow portion of the tube and configured to react with the chemical of interest causing a change to transmissiveness of light;
a light source configured to illuminate the reactant;
a photodetector configured to detect light traversing the reactant;
a processor coupled to the photodetector and configured to determine a rate of change of detected light in response to the chemical of interest reacting with the reactant in order to sense the chemical of interest; and
a reactant purging system in fluid communication with the hollow portion and configured to purge out pre-existing reactant present in the hollow portion with new unreacted reactant.

2. The apparatus according to claim 1, wherein the processor is further configured to determine a concentration of the chemical of interest in the fluid of interest by correlating the rate of change to the concentration.

3. The apparatus according to claim 2, wherein the rate of change comprises a first derivative of a value of an output of the photodetector over time.

4. The apparatus according to claim 3, wherein the processor is further configured to determine the first derivative using a Savitzky-Golay digital filter.

5. The apparatus according to claim 1, wherein the reactant purging system comprises:
a reservoir configured to contain unreacted reactant; and
a waste chamber configured to contain reacted reactant.

6. The apparatus according to claim 5, the reactant purging system further comprising:
a pump configured to pump the unreacted reactant from the reservoir into the hollow portion of the capillary tube;
a tube isolation valve configured to isolate the reactant in the hollow portion of the capillary tube; and
a reactant purging system controller in communication with the pump and the isolation valve and configured to operate the pump and the isolation valve to purge out the pre-existing reactant present in hollow portion with the new unreacted reactant.

7. The apparatus according to claim 1, further comprising a pressure balancing piston in pressure communication with the reactant disposed in the hollow portion of the capillary tube.

8. The apparatus according to claim 1, further comprising a sample chamber configured to contain a sample of the fluid of interest, wherein the capillary tube is disposed within the sample chamber.

9. The apparatus according to claim 8, further comprising a sample purging system configured to purge a pre-existing sample of the fluid of interest in the sample chamber with a new sample of the fluid of interest.

10. The apparatus according to claim 9, wherein the sample purging system comprises:
a sample purging pump configured to pump a sample of the fluid of interest into the sample chamber;
a sample chamber isolation valve configured to isolate the sample of the fluid of interest in the sample chamber; and
a sample purging system controller in communication with the sample purging pump and the sample chamber isolation valve and configured to operate the sample purging pump and the sample chamber isolation valve to purge out the pre-existing sample of the fluid of interest present in sample chamber with the new sample of the fluid of interest.

11. The apparatus according to claim 1, wherein the chemical of interest of interest is a gas.

12. The apparatus according to claim 1, wherein the chemical of interest includes at least one of hydrogen sulfide (H2S), carbon dioxide, and sulfur dioxide.

13. The apparatus according to claim 1, wherein the fluid of interest is oil.

14. The apparatus according to claim 1, further comprising a carrier configured to be conveyed through a borehole penetrating an earth formation, the capillary tube being disposed on the carrier, wherein the fluid of interest is a formation fluid.

15. The apparatus according to claim 14, wherein the polymer is configured to withstand temperatures in a downhole environment.

16. The apparatus according to claim 15, wherein the polymer comprises one or more sulfone polymers.

17. The apparatus according to claim 16, wherein the polymer comprises one or more of a polysulfone, a polyethersulfone, a polyphenylsulfone, a polyetherimide, or a combination thereof.

18. The apparatus according to claim 1, wherein the reactant comprises one of more of lead, lead acetate, iron, an iron compound, ferric acid, elemental iron particles, an organic compound, or combination thereof.

19. A method for sensing a chemical of interest in a fluid of interest, the method comprising:
disposing a tube in the fluid of interest, the capillary tube being permeable to the chemical of interest and comprising a polymer;
disposing a reactant in a hollow portion of the tube, the reactant being configured to react with the chemical of interest causing a change to transmissiveness of light of the reactant;
illuminating the reactant using a light source;
detecting light traversing the reactant using a photodetector;
determining a rate of change of detected light over time in response to the chemical of interest reacting with the reactant using a processor in order to sense the chemical of interest; and
purging out pre-existing reactant present in the hollow portion with new unreacted reactant using a reactant purging system.

20. The method according to claim 19, further comprising conveying a carrier through a borehole penetrating an earth formation, the tube being disposed on the carrier, wherein the fluid of interest is a formation fluid.
